(19) United States
(12) Patent Application Publication
(10) Pub. No.: US 2018/0232438 A1
(43) Pub. Date: Aug. 16, 2018

(54) TITLE DISPLAY METHOD AND APPARATUS

(71) Applicant: Alibaba Group Holding Limited, Grand Cayman (KY)

(72) Inventors: Yang Gu, Hangzhou (CN); Kairi Ou, Hangzhou (CN)

(21) Appl. No.: 15/953,336

(22) Filed: Apr. 13, 2018

Related U.S. Application Data
(63) Continuation of application No. PCT/CN2016/101450, filed on Oct. 8, 2016.

(30) Foreign Application Priority Data
Oct. 16, 2015 (CN) 201510671264.4

(51) Int. Cl. G06F 17/30

(52) U.S. Cl. CPC G06F 17/30696; G06F 17/30707; G06F 17/30867

(57) ABSTRACT

A method including classifying a plurality of users into different user groups according to at least one attribute information of the plurality of users; determining a keyword corresponding to each user group according to historical user behavior logs of different user groups; receiving a request of a current user for accessing a current transaction object, and determining a user group of the current user according to attribute information of the current user; segmenting an original title of the current transaction object into word segments, and determining a word segment matching the keyword corresponding to the user group of the current user in the word segments; generating a new title of the transaction object according to the matching word segment for display at a user client terminal. The techniques of the present disclosure ensure that a title displayed to a user is short and meets personalized demands of the user.

### CROSS REFERENCE TO RELATED PATENT APPLICATIONS

This application claims priority to and is a continuation of PCT Patent Application No. PCT/CN2016/101450, filed on 8 Oct. 2016, which claims priority to Chinese Patent Application No. 201510671264.4, filed on Oct. 16, 2015 and entitled “TITLE DISPLAY METHOD AND APPARATUS”, which are incorporated herein by reference in their entirety.

### TECHNICAL FIELD

The present disclosure relates to the field of Internet information displaying technologies, and, more particularly, to title display methods and apparatuses.

### BACKGROUND

Generally, when network contents are displayed, each network content includes a title. A user may quickly learn important information about the network content by viewing the title.

In an e-commerce system, an existing title display method generally includes: adding a title of a product by a product provider according to product information, and displaying the added title to a user. A short title corresponding to the title of the product may also be added when the product provider adds the title. Thus, the short title may be provided to the user when the user finds the product through search using a mobile terminal.

A product provider generally adds a long title for a product and adds up-to-date hot words to the title of the product, so that the users may easily find the product. Displaying an excessively long title may require a large space on the screen of a user terminal, making it inconvenient for the user to read. What's worse, when a title is excessively long, it is very difficult for the user to quickly locate the part that he/she is interested in. On the other hand, the existing title providing method cannot meet personalized demands of users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The example embodiments of the present disclosure provide title display methods and apparatuses, to ensure that a title displayed to a user is short and meets personalized demands of the user.

To solve the above technical problem, the example embodiments of the present disclosure provide the title display methods and apparatuses that are implemented as follows.

The present disclosure provides a method including:
receiving a request of a user for accessing an item; and
generating a new title of the item for display at a user client terminal of the user according to attribute information of the user and an original title of the item, the new title being different from the original title of the item.

For example, the item includes a transaction object that may represent a product or service for sale at a website. The new title is shorter than the original title.

For example, the new title to be presented at a user terminal of the first user is different from the new title to be presented at a user terminal of the second user.

The present disclosure also provides a title display method includes:
classifying a plurality of users into different user groups according to at least one attribute information of the plurality of users;
determining keywords corresponding to each user group according to historical user behavior logs of the different user groups;
receiving a request of a current user for accessing a current transaction object, and determining a user group of the current user according to attribute information of the current user;
segmenting an original title of the current transaction object into word segments, and determining word segments matching the keywords corresponding to the user group of the current user in the word segments;
generating a new title of the transaction object according to the matching word segments; and
returning the new title to a user client terminal for displaying.

For such keywords corresponding to each user group may be the keywords preferred by each user group according to statistics, which may be obtained from the historical user behavior logs of each user group.

A title display apparatus includes: a user group classification unit, a preferred keyword unit, a current user unit, a word segment matching unit, a new title unit, and a displaying unit, wherein
the user group classification unit is configured to classify a plurality of users into different user groups according to at least one attribute information of the plurality of users;
the preferred keyword unit is configured to determine keywords corresponding to each user group according to historical user behavior logs of different user groups;
the current user unit is configured to receive a request of a current user for accessing a current transaction object, and determine a user group of the current user according to attribute information of the current user;
the word segment matching unit is configured to segment an original title of the current transaction object into word segments, and determine word segments matching the keywords corresponding to the user group of the current user in the word segments;
the new title unit is configured to generate a new title of the transaction object according to the matching word segments in the word segment matching unit; and
the displaying unit is configured to return the new title in the new title unit to a user client terminal for displaying.

As shown from the technical solutions provided in the example embodiments of the present disclosure, under the title display method and apparatus disclosed in the example embodiments of the present disclosure, users are classified according to attribute information of the users, a user group corresponding to each user and keywords corresponding to each user group are predetermined, an original title of a current transaction object is segmented into word segments when a request of a user for accessing the current transaction object is received to determine word segments in the original title that match the keywords corresponding to the group to which the user belongs, and then a new title is generated according to the matching word segments and displayed to the user. The techniques of the present disclosure may ensure that the title displayed to the user is simplified. Meanwhile, by using the title display method and apparatus disclosed in the example embodiments of the present disclosure, a title meeting a search habit of a user group to which a user belongs may be generated and displayed according to the user group, and the title displayed to the user may meet personalized demands of the user.

### BRIEF DESCRIPTION OF THE DRAWINGS

To describe the technical solutions in the example embodiments of the present disclosure or the prior art more clearly, the following briefly introduces the accompanying drawings describing the example embodiments. Apparently, the accompanying drawings described in the following are merely some example embodiments described in the present disclosure, and those of ordinary skill in the art may still derive other drawings from these accompanying drawings without creative efforts.

FIG. 1 is a flowchart of an example embodiment of a title display method according to the present disclosure; and

FIG. 2 is a block diagram of an example embodiment of a title display apparatus according to the present disclosure.

### DETAILED DESCRIPTION

The example embodiments of the present disclosure provide title display methods and apparatuses.

In order to enable those skilled in the art to better understand the technical solutions in the present disclosure, the technical solutions in the example embodiments of the present disclosure will be described clearly and completely through the accompanying drawings in the example embodiments of the present disclosure. Apparently, the described example embodiments are merely some of example embodiments of the present disclosure, rather than all the example embodiments. Based on the example embodiments of the present disclosure, all other example embodiments derived by those of ordinary skill in the art without any creative effort shall fall within the protection scope of the present disclosure.

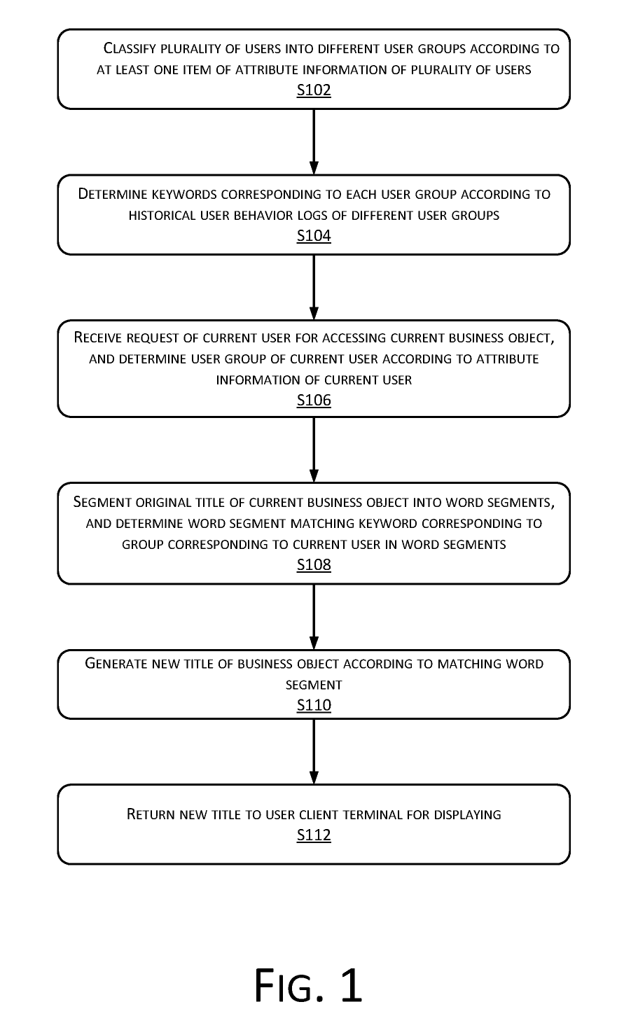

FIG. 1 is a flowchart of an example embodiment of a title display method according to the present disclosure. As shown in FIG. 1, the title display method may include:

S102: A plurality of users are classified into different user groups according to at least one item of attribute information of the plurality of users.

A plurality of users may be classified according to attribute information of the users, to obtain user groups corresponding to different attribute information.

The attribute information of the user may include at least one of the following: region, gender, body type, financial capacity, activeness, preferences, and the like.

For example, when the attribute information is region information of users, the users may be classified into a user group “northern” and a user group “southern” in the dimension of region. When the attribute information is body type information of users, the users may be classified into a user group “chubby” and a user group “slim” in the dimension of body type.

The method for classifying user groups may vary with different dimensions. A user may have attribute information in a plurality of different dimensions, and therefore, one user may correspond to user groups in one or more dimensions. For example, a user has attribute information “southern” in the dimension of region, and the user may be classified into the user group “southern”; meanwhile, the user has attribute information “slim” in the dimension of body type, and the user may also be classified into the user group “slim”.

S104: Keywords corresponding to each user group may be determined according to historical user behavior logs of different user groups.

The keywords corresponding to the user group may correspond to the user group. The keywords corresponding to the user group may be query words commonly used when the user group searches for products.

The historical user behavior log may include: a user search log. The user search log may record a search time and a query word of the user.

Keywords corresponding to each user group may be determined according to the user search logs. For example, the total number of searches in all user search logs in each user group and the number of searches corresponding to each query word may be counted. A ratio of the number of searches of each query word to the total number of searches may be calculated. If the ratio is greater than a predetermined value, the query word may be determined as a keyword corresponding to the user group.

In another implementation, the total number of searches in all user search logs in each user group and the number of searches corresponding to each query word within a preset period of time may be counted. A ratio of the number of searches of each query word to the total number of searches counted within the preset period of time is then calculated. If the ratio is greater than a predetermined value, the query word may be determined as a keyword corresponding to the user group.

For example, the users may be classified into the user group “chubby” and the user group “slim” according to attribute information in the dimension of body type. Keywords corresponding to the user group “chubby” may be determined according to historical user behavior logs of the user group “chubby”. For example, the total number of searches in all user search logs of the user group “chubby” within the last 30 days may be counted, which, for example, may be represented by N. The number of searches corresponding to each query word in all user search logs of the user group “chubby” within the last 30 days may also be counted, which, for example, may be represented by M1, M2, M3, or the like. A ratio of the number of searches of each query word to the total number of searches is calculated, that is, M1/N, M2/N, M3/N, or the like. For example, M1 represents the number of searches of a query word “loose”, M2 represents the number of searches of a query word “large-size”, and M3 represents the number of searches of a query word “low-price”. Assuming that values of M1/N and M2/N are greater than a preset value and a value of M3/N is less than the preset value, it may be determined that “loose” and “large-size” are keywords corresponding to the user group “chubby”.

S106: A request of a current user for accessing a current transaction object is received, and a user group of the current user is determined according to attribute information of the current user.

The request of the current user for accessing the current transaction object may include: a request for displaying a title of the current transaction object on a display screen of the current user. The current transaction object may be a product in the field of e-commerce.

After the request of the current user for accessing the current transaction object is received, the user group of the current user may be determined according to the attribute information of the current user. For example, referring to the description in step S102, the attribute information of the current user is, for example, “southern” in the dimension of region, the current corresponding user group may be determined as the user group “southern”.

S108: An original title of the current transaction object is segmented into word segments, and a word segment matching the keyword corresponding to the user group of the current user in the word segments is determined.

The original title of the current transaction object may be segmented into a plurality of word segments. For example, the current transaction object is a coat, and an original title of the transaction object may be “Korean-style big-epaulettes mid-long spring/autumn clothing women's trench coat loose fashionable”. The original title may be segmented into the following word segments: “Korean-style”, “big-epaulettes”, “mid-long”, “long”, “spring/autumn clothing”, “autumn clothing”, “women's”, “trench”, “coat”, “loose”, and “fashionable”.

In the word segments, the word segments matching the keywords corresponding to the user group of the current user may include: word segments identical to or equivalent to the keywords corresponding to the user group of the current user.

It is assumed that user groups corresponding the current user may include: a group “women”, a group “young”, and a group “chubby”. Keywords corresponding to the group “women” may include: “women's”; keywords corresponding to the group “young” may include: “fashionable”; keywords corresponding to the group “chubby” may include: “loose”. Therefore, in the word segments, the word segments matching the keywords corresponding to the user group of the current user may include: “women's”, “loose”, and “fashionable”.

S110: A new title of the transaction object is generated according to the matching word segment.

The new title of the transaction object may be generated according to the matching word segments. For example, the matching word segments may be combined with a preset simplified title of the transaction object to generate the new title of the transaction object.

Further, the combining the matching word segments with a preset simplified title of the transaction object to generate the new title of the transaction object may include combining the word segments with the preset simplified title directly to generate the new title of the transaction object. The word segments may be directly combined with the preset simplified title in a random or preset order.

Further, the combining the matching word segments with a preset simplified title of the transaction object to generate the new title of the transaction object may further include, after using the direct combination manner, deleting repeated word segments in a title formed by combining the word segments with the preset simplified title, and using a title obtained by deleting the repeated word segments as the new title of the transaction object.

For example, for the transaction object having the original title “Korean-style big-epaulettes mid-long spring/autumn clothing women's trench coat loose fashionable”, it is assumed that a preset simplified title is “women's trench coat”, and matching word segments are “women's”, “loose”, and “fashionable”. Therefore, the matching word segments are directly combined with the preset simplified title of the transaction object, and a new title “women's loose fashionable women's trench coat” of the transaction object may be obtained. If repeated word segments in the combined title are further deleted, a new title “loose fashionable women's trench coat” of the transaction object may be obtained.

In another example embodiment, after the matching word segments are combined with the preset simplified title of the transaction object to generate the title, the step of generating a new title of the transaction object according to the matching word segments may further include: determining a feature word corresponding to the transaction object according to attribute information of the transaction object, and generating the new title based on the feature word and the title generated according to the word segments.

The step of determining a feature word corresponding to the transaction object according to attribute information of the transaction object may include: determining the feature word corresponding to the transaction object according to provider information of the transaction object, and/or, determining the feature word corresponding to the transaction object according to feedback information of the transaction object.

The provider information of the transaction object may include at least one of the following: a provider identifier of the transaction object, a share of the provider of the transaction object in the industry to which the transaction object belongs, attribute information of a search user corresponding to the transaction object, and brand information of the transaction object.

The feature word corresponding to the transaction object may be determined according to the provider information of the transaction object. For example, the feature word may include: “top 100 in the industry”, “centennial history”, “women's choices”, a brand name of the transaction object, and the like.

The feature word corresponding to the transaction object may further be determined according to the feedback information of the transaction object. The feedback information may be comments of users on the transaction object. For example, the feature word may include “thumbs up”, “high price-performance ratio”, and the like.

The step of generating the new title based on the feature word and the title generated according to the word segments may include: adding the feature word to the title generated according to the word segments.

S112: The new title is returned to a user client terminal for displaying.

The new title returned to the user client terminal for displaying may be generated by combining the matching word segments with the preset simplified title of the transaction object.

In another example embodiment, the new title returned to the user client terminal for displaying may also be a new title formed by adding the feature word to the title generated according to the word segments.

Under the title display method disclosed in the example embodiments of the present disclosure, users are classified according to attribute information of the users, a user group corresponding to each user and keywords corresponding to each user group are predetermined, an original title of a current transaction object is segmented into word segments when a request of a user for accessing the transaction object is received to determine word segments in the original title that match the keywords corresponding to the group to which the user belongs, a new title is then generated according to the matching word segments and a preset simplified title, and the new title is displayed to the user. The techniques of the present disclosure ensure that the title displayed to the user is simplified. Meanwhile, by using the title display method disclosed in the example embodiments of the present disclosure, a title meeting a search habit of a user group to which a user belongs may be generated and displayed according to the user group, and the title displayed to the user may meet personalized demands of the user.

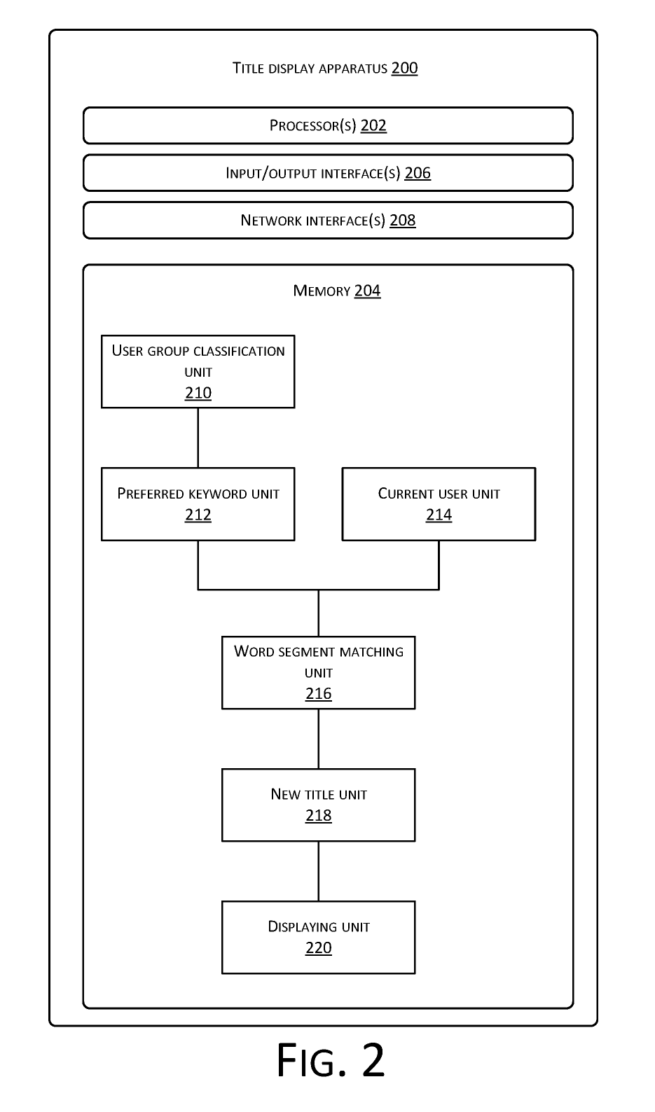

FIG. 2 is a block diagram of an example embodiment of a title display apparatus 200 according to the present disclosure. As shown in FIG. 2, the title display apparatus 200 includes one or more processor(s) 202 or data processing unit(s) and memory 204. The title display apparatus 200 may further include one or more input/output interface(s) 206 and one or more network interface(s) 208. The memory 204 is an example of computer readable media.

The memory 204 may store therein a plurality of modules or units including a user group classification unit 210, a preferred keyword unit 212, a current user unit 214, a word segment matching unit 216, a new title unit 218, and a displaying unit 220.

The user group classification unit 210 may be configured to classify a plurality of users into different user groups according to at least one item of attribute information of the plurality of users.

The preferred keyword unit 212 may be configured to determine keywords corresponding to each user group according to historical user behavior logs of different user groups.

The current user unit 214 may be configured to receive a request of a current user for accessing a current transaction object, and determine a user group of the current user according to attribute information of the current user.

The word segment matching unit 216 may be configured to segment an original title of the current transaction object into word segments, and determine word segments matching the keywords corresponding to the user group of the current user in the word segments.

The new title unit 218 may be configured to generate a new title of the transaction object according to the matching word segments determined in the word segment matching unit 216.

In another example embodiment, the new title unit 218 may further be configured to determine a feature word corresponding to the transaction object according to attribute information of the transaction object, and generate the new title based on the feature word and the title generated according to the word segments.

The displaying unit 220 may be configured to return the new title in the new title unit 218 to a user client terminal for displaying.

The title display apparatus disclosed in the above example embodiment corresponds to the example embodiment of the title display method according to the present disclosure, and may implement the example embodiment of the title display method according to the present disclosure and achieve technical effects of the method example embodiment.

In the 1990s, an improvement in a technology may be obviously distinguished as an improvement in hardware (for example, an improvement in a circuit structure such as a diode, a transistor, or a switch) or an improvement in software (an improvement in a method procedure). However, with the development of technologies, improvements in many method procedures at present may be considered as direct improvements in hardware circuit structures. Almost all designers program the improved method procedures into hardware circuits to obtain corresponding hardware circuit structures. Therefore, it is improper to assume that an improvement in a method procedure cannot be implemented by using a hardware entity module. For example, a Programmable Logic Device (PLD) (such as a Field Programmable Gate Array (FPGA)) is such an integrated circuit whose logic functions are determined by a user by programming a device. Designers perform programming to “integrate” a digital system on a PLD without the need to ask a chip manufacturer to design and manufacture a dedicated integrated circuit chip 2. Moreover, at present, the programming is mostly implemented by using “logic compiler” software, instead of manually manufacturing an integrated circuit chip. The logic compiler software is similar to a software complier used for developing and writing a program, and original code before compiling also needs to be written in a specific programming language, which is referred to as a Hardware Description Language (HDL). There are many types of HDLs such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL), in which Very-High-Speed Integrated Circuit Hardware Description Language (VHDL) and Verilog 2 are most commonly used at present. Those skilled in the art also should know that a hardware circuit for implementing the logic method procedure may be easily obtained by slightly programming the method procedure logically in the above several hardware description languages and programming it into an integrated circuit.

A controller may be implemented in any suitable manner. For example, the controller may be in the form of a microprocessor or a processor and a computer readable medium storing computer readable program code (for example, software or firmware) executable by the (micro)processor, a logic gate, a switch, an application-specific integrated circuit (ASIC), a programmable logic controller, and an embedded micro-controller. Examples of the controller include, but are not limited to, the following micro-controllers: ARC 625D, Atmel AT91SAM, Microchip PIC18F26K20, and Silicone Labs C8051F320. A memory controller may also be implemented as a part of control logic of a memory.

Those skilled in the art also know that the controller may be implemented by using pure computer readable program code, and in addition, the method steps may be logically programmed to enable the controller to implement the same function in the form of a logic gate, a switch, an ASIC, a programmable logic controller and an embedded microcontroller. Therefore, this type of controller may be considered as a hardware component, and apparatuses included in the controller for implementing various functions may also be considered as structures inside the hardware component. Alternatively, the apparatuses used for implementing various functions may even be considered as both software modules for implementing the method and structures inside the hardware component.

The system, apparatus, module or unit illustrated in the above example embodiments may be implemented by using a computer chip or an entity, or a product having a particular function.

For ease of description, when the foregoing apparatus is described, it is divided into various units based on functions for respective descriptions. Definitely, when the present disclosure is implemented, functions of the units may be implemented in the same or a plurality of pieces of software and/or hardware.

Based on the foregoing descriptions of the implementations, those skilled in the art may clearly understand that the present disclosure may be implemented by software plus a necessary universal hardware platform. Based on such an understanding, the technical solutions of the present disclosure essentially or the part contributing to the prior art may be implemented in a form of a software product. In a typical configuration, a computing device includes one or more processors (CPU), an input/output interface, a network interface, and a memory. The computer software product may include several instructions for instructing a computer device (which may be a personal computer, a server, a network device, or the like) to perform the methods described in the example embodiments or some parts of the present disclosure. The computer software product may be stored in a memory, and the memory may include a volatile memory, a random access memory (RAM) and/or a non-volatile memory or the like in a computer readable medium, for example, a read only memory (ROM) or a flash RAM. The memory is an example of the computer readable medium. The computer readable medium includes non-volatile and volatile media as well as movable and non-movable media, and may implement information storage by means of any method or technology. Information may be a computer readable instruction, a data structure, and a module of a program or other data. An example of the storage medium of a computer includes, but is not limited to, a phase-change memory (PRAM), a static random access memory (SRAM), a dynamic random access memory (DRAM), other types of RAMs, a ROM, an electrically erasable programmable read-only memory (EEPROM), a flash memory or other memory technologies, a compact disc read-only memory (CD-ROM), a digital versatile disc (DVD) or other optical storages, a cassette tape, a magnetic tape/magnetic disk storage or other magnetic storage devices, or any other non-transmission medium, and may be used to store information accessible by the computing device. According to the definition in this text, the computer readable medium does not include transitory computer readable media (transitory media) such as a modulated data signal and carrier.

The example embodiments in this specification are described progressively, identical or similar parts of the example embodiments may be obtained with reference to each other, and each example embodiment emphasizes a part different from other example embodiments. Especially, the system example embodiment is basically similar to the method example embodiment and is therefore described simply. For related parts, reference may be made to the descriptions of the parts in the method example embodiment.

The present disclosure may be applicable to various universal or dedicated computer system environments or configurations such as a personal computer, a server computer, a handheld device or a portable device, a tablet device, a multi-processor system, a microprocessor-based system, a set top box, a programmable consumer electronic device, a network PC, a microcomputer, a mainframe computer, and a distributed computing environment including any of the above systems or devices.

The present disclosure may be described in a common context of a computer executable instruction executed by a computer, for example, a program module. Generally, the program module includes a routine, a program, an object, an assembly, a data structure, and the like used for executing a specific task or implementing a specific abstract data type. The present disclosure may also be practiced in distributed computing environments. In these distributed computing environments, a task is executed by using remote processing devices connected through a communications network. In the distributed computing environments, the program module may be located in local and remote computer storage media including a storage device.

Although the present disclosure is described through example embodiments, those of ordinary skill in the art should know that the present disclosure has many variations and changes without departing from the spirit of the present disclosure, and it is expected that the appended claims cover the variations and changes without departing from the spirit of the present disclosure.

The present disclosure may further be understood with clauses as follows.

Clause 1. A title display method, comprising:
classifying a plurality of users into different user groups according to at least one attribute information of the plurality of users;
determining a keyword preferred by each user group according to historical user behavior logs of different user groups;
receiving a request of a current user for accessing a current transaction object, and determining a user group corresponding to the current user according to attribute information of the current user;
segmenting an original title of the current transaction object into word segments, and determining a word segment matching the keyword preferred by the user group corresponding to the current user in the word segments;
generating a new title of the transaction object according to the matching word segment; and
returning the new title to a user client terminal for displaying.

Clause 2. The title display method of clause 1, wherein the attribute information comprises at least one of the following: a region, a gender, a body type, a financial capacity, an activeness, and a preference.

Clause 3. The title display method of clause 1, wherein one user corresponds to one or more user groups.

Clause 4. The title display method of clause 1, wherein the historical user behavior logs comprise: a user search log, wherein the user search log records a search time and a query word of the user.

Clause 5. The title display method of clause 4, wherein the determining keywords preferred by each user group according to historical user behavior logs of different user groups comprises:
counting a total number of searches in all user search logs in each user group and a number of searches corresponding to each query word in all user search logs in each user group;
calculating a ratio of the number of searches of each query word to the total number of searches; and
determining the query word as a keyword preferred by the user group in response to determining that the ratio is greater than a predetermined value.

Clause 6. The title display method of clause 4, wherein the determining the keyword preferred by each user group according to the historical user behavior logs of different user groups comprises:
counting a total number of searches in all user search logs in each user group and a number of searches corresponding to each query word in all user search logs in each user group within a preset period of time;
calculating a ratio of the number of searches of each query word to the total number of searches counted within the preset period of time; and determining the query word as the keyword preferred by the user group in response to determining that the ratio is greater than a predetermined value.

Clause 7. The title display method of clause 1, wherein, in the word segments, the word segment matching the keywords preferred by the user group corresponding to the current user comprise: a word segment identical to or equivalent to the keyword preferred by the user group corresponding to the current user.

Clause 8. The title display method of clause 1, wherein the generating the new title of the transaction object according to the matching word segments comprises combining the matching word segment with a preset simplified title of the transaction object to generate the new title of the transaction object.

Clause 9. The title display method of clause 8, wherein the combining the matching word segment with the preset simplified title of the transaction object to generate the new title of the transaction object comprises combining the word segment with the preset simplified title of the transaction object directly to generate the new title of the transaction object, the word segments being directly combined with the preset simplified title in a random or preset order.

Clause 10. The title display method of clause 8, wherein the combining the matching word segment with the preset simplified title of the transaction object to generate the new title of the transaction object comprises,
after using a direct combination manner, deleting a repeated word segment in a title formed by combining the matching word segment and the preset simplified title; and
using a title obtained by deleting the repeated word segments as the new title of the transaction object.

Clause 11. The title display method of clause 8, wherein the generating the new title of the transaction object according to the matching word segment further comprises:
determining a feature word corresponding to the transaction object according to attribute information of the transaction object; and
generating the new title based on the feature word and the title generated according to the word segment.

Clause 12. The title display method of clause 11, wherein the generating the new title based on the feature word and the title generated according to the word segment comprises: adding the feature word to the title generated according to the word segment.

Clause 13. The title display method of clause 11, wherein the determining the feature word corresponding to the transaction object according to the attribute information of the transaction object comprises:
determining the feature word corresponding to the transaction object according to provider information of the transaction object; and/or
determining the feature word corresponding to the transaction object according to feedback information of the transaction object.

Clause 14. The title display method of clause 13, wherein the provider information of the transaction object comprises at least one of the following:
a provider identifier of the transaction object;
a share of a provider of the transaction object in the industry to which the transaction object belongs;
attribute information of a search user corresponding to the transaction object; and brand information of the transaction object.

Clause 15. A title display apparatus comprising:
a user group classification unit;
a preferred keyword unit;
a current user unit;
a word segment matching unit;
a new title unit; and
a displaying unit,
wherein:
the user group classification unit is configured to classify a plurality of users into different user groups according to at least one attribute information of the plurality of users;
the preferred keyword unit is configured to determine a keyword preferred by each user group according to historical user behavior logs of different user groups;
the current user unit is configured to receive a request of a current user for accessing a current transaction object, and determine a user group corresponding to the current user according to attribute information of the current user;
the word segment matching unit is configured to segment an original title of the current transaction object into word segments, and determine a word segment matching the keyword preferred by the user group corresponding to the current user in the word segments;
the new title unit is configured to generate a new title of the transaction object according to the matching word segment in the word segment matching unit; and
the displaying unit is configured to return the new title in the new title unit to a user client terminal for displaying.

Clause 16. The title display apparatus of clause 15, wherein the new title unit is further configured to generate a feature word corresponding to the transaction object according to attribute information of the transaction object, and generate the new title based on the feature word and the title generated according to the word segments.

What is claimed is:

1. A method comprising:
receiving a request of a first user for searching for an item; and
generating a new title of the item for display at a user client terminal of the first user according to attribute information of the first user and an original title of the item, the new title being different from the original title of the item.

2. The method of claim 1, wherein the item includes a transaction object.

3. The method of claim 1, further comprising returning the new title to the user client terminal for displaying.

4. The method of claim 1, wherein the generating the new title of the item for display at the user client terminal of the user includes:
generating the new title according to a word segment in the original title of the item and attribute information of the first user, the new title being shorter than the original title.

5. The method of claim 1, wherein the generating the new title according to the word segment in the original title of the item and attribute information of the first user r includes:
determining a user group for the first user according to the attribute information of the first user, wherein each user belongs to a user group, and wherein each user group have a preference keyword;
segmenting the original title of the item into one or more word segments;
determining the word segment of the one or more word segments matching the keyword corresponding to the user group for the first user in the one or more word segments; and
generating the new title of the item according to the matching word segment.

6. The method of claim 5, wherein the attribute information includes at least one of the following:
a region;
a gender;
a body type;
a financial capacity;
an activeness; and
user preference.

7. The method of claim 5, wherein the user corresponds to one or more user groups.

8. The method of claim 5, wherein the determining the keyword corresponding to each user group of the different user groups includes:
determining the keyword corresponding to each user group of the different user groups according to historical user behavior logs of each user group.

9. The method of claim 8, wherein the historical user behavior logs include a user search log, wherein the user search log records a search time and a query word of the user.

10. The method of claim 8, wherein the determining the keyword corresponding to each user group of the different user groups according to historical user behavior logs of each user group includes:
counting a total number of searches in all user search logs in the user group and a number of searches corresponding to each query word in all user search logs in the user group;
calculating a ratio of the number of searches of each query word to the total number of searches; and
determining the query word as a keyword corresponding to the user group in response to determining that the ratio is greater than a predetermined value.

11. The method of claim 8, wherein the determining the keyword corresponding to each user group of the different user groups according to historical user behavior logs of each user group includes:
counting a total number of searches in all user search logs in the user group and a number of searches corresponding to each query word in all user search logs in the user group within a preset period of time;
calculating a ratio of the number of searches of each query word to the total number of searches counted within the preset period of time; and
determining the query word as the keyword corresponding to the user group in response to determining that the ratio is greater than a predetermined value.

12. The method of claim 5, wherein the word segment matching the keyword corresponding to the user group includes a word segment identical to or equivalent to the keyword corresponding to the user group of the current user.

13. The title display method of claim 5, wherein the generating the new title of the item according to the matching word segment includes:
combining the matching word segment with a preset simplified title of the item to generate the new title of the item.

14. The method of claim 13, wherein combining the matching word segment with a preset simplified title of the item to generate the new title of the item includes:
combining the word segment with the preset simplified title of the item directly to generate the new title, the word segments being directly combined with the preset simplified title in a random or a preset order.

15. The title display method of claim 14, wherein combining the matching word segment with a preset simplified title of the item to generate the new title of the item further includes:
deleting a repeated word segment in the new title.

16. The title display method of claim 5, wherein the generating the new title of the item according to the matching word segment includes:
determining a feature word corresponding to the item according to attribute information of the item; and
generating the new title based on the feature word and the word segment.

17. The method of claim 11, wherein the determining the feature word corresponding to the item according to attribute information of the item includes:
determining the feature word corresponding to the item according to provider information of the item.

18. The method of claim 11, wherein the determining the feature word corresponding to the item according to attribute information of the item includes:
determining the feature word corresponding to the item according to feedback information of the item.

19. An apparatus comprising:
one or more processors; and
one or more memories storing thereon computer-readable instructions that, when executed by the one or more processors, cause the one or more processors to perform acts comprising:
classifying a plurality of users into different user groups according to at least one attribute information of the plurality of users;
determining a keyword corresponding to a respective user group according to historical user behavior logs of the different user groups;
receiving a request of a user for searching for an item;
determining a user group of the user according to attribute information of the user;
segmenting an original title of the item into one or more word segments;
determining a word segment matching the keyword from the one or more word segments corresponding to the user group of the user in the word segments; and
generating a new title of the item at least according to the matching word segment.

20. One or more memories storing thereon computer-readable instructions that, when executed by one or more processors, cause the one or more processors to perform acts comprising:
receiving a first request of a first user for searching for an item'
receiving a second request of a second user for accessing the item;
generating a first new title of the item for display at a first user client terminal of the first user according to attribute information of the first user and an original title of the item; and
generating a second new title of the item for display at a second user client terminal of the second user according to attribute information of the second user and the original title of the item, the first new title being different from the second new title, the first new title and the second new title being shorter than the original title of the item.
